(19) United States
(12) Patent Application Publication
(10) Pub. No.: US 2010/0146412 A1
(43) Pub. Date: Jun. 10, 2010

(54) COMMUNICATION APPARATUS AND METHOD FOR VISITING AND BROWSING WEB PAGES

(75) Inventor: Kazuhiro NAGASE, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/493,543

(22) Filed: Jun. 29, 2009

(30) Foreign Application Priority Data
Dec. 5, 2008 (JP) 2008-311039

(51) Int. Cl. G06F 3/048

(52) U.S. Cl. 715/760; 715/863; 345/173

(57) ABSTRACT

A communication apparatus having a touch screen, a memory and a controller, and configured to be used for visiting and browsing web pages is provided. The touch screen is configured to display a visited web page, and to sense a first operation and a second operation performed on the touch screen. The first operation and the second operation are different from each other. The memory is configured to store history data of a plurality of visited web pages. The controller is configured to allow returning from a current web page to a preceding web page listed immediately before the current web page in the history data upon the touch screen sensing the first operation. The controller is configured to allow continuing from the current web page to a next web page listed immediately after the current web page in the history data upon the touch screen sensing the second operation.

### CROSS REFERENCE TO RELATED APPLICATIONS

This application is based upon and claims the benefit of priority from the prior Japanese Patent Application No. 2008-311039 filed on Dec. 5, 2008;

the entire contents of which are incorporated herein by reference.

### BACKGROUND OF THE INVENTION

1. Field of the Invention

The present invention relates to a communication apparatus and a method for visiting and browsing web pages, and in particular to a communication apparatus having a touch screen for displaying visited web pages.

2. Description of the Related Art

It is generally known that some communication apparatus has a web browser function for browsing a web page obtained from a server. Such a web browser is configured to perform various functions such as screen scrolling for displaying a portion of the page that remains outside of a screen on the display, a hyperlink function for jumping from the current web page to another web page, functions for continuing or returning from the current page to the next or preceding page, and so on. These functions can enable a user of the communication apparatus to smoothly browse web pages.

A technology for providing a control area on a displayed screen so as to accept a command for performing a function such as page scrolling is known, e.g., as disclosed in Japanese Patent Publication of Unexamined Applications (Kokai), No. 2006-323793. According to JP 2006-323793, functions for continuing, returning and so on are assigned to the above control area in accordance with a position of a pointer displayed on the screen, so as to allow a user to enjoy browsing content such as web pages with less workload.

Some communication apparatus such as a mobile phone has a plurality of operation keys such as numeric keys, a navigation key and so on which are assigned as short cut keys to the functions such as page scrolling and so on described above. The communication apparatus can be directed through the short cut keys to perform the functions. A user of the communication apparatus can smoothly browse web pages with a small number of operations not through a displayed user interface but by using these short cut keys.

In recent years, it is known that some communication apparatus has a display configured as a touch sensor. It is also known that some communication apparatus having a touch sensor has an input device only formed by the touch sensor and has no numeric or navigation keys, or only has a limited number of operation keys. A communication apparatus having a touch sensor has an advantage in that a user of the communication apparatus can more intuitively perform an input operation. Intuitive operations on a display are, e.g., touching the display, tracing the display in horizontal and vertical directions and so on. The communication apparatus is configured to perform a particular function assigned to each of those operations.

A communication apparatus having a web browser function, e.g., can allow a touch operation on a hyperlink included in a web page displayed on a display so as to jump to a linked page, or can allow a trace operation on the web page in horizontal and vertical directions so as to scroll the page. A user of the communication apparatus can intuitively operate the communication apparatus so as to perform various functions.

A communication apparatus having an input device including operation keys such as a plurality of numeric keys and a navigation key can assign as many short cut keys as the number of the operation keys. Meanwhile, the number of instructions that a communication apparatus having a touch sensor as an input device can accept depends on the number of different operations that the touch sensor can distinguish from one another. Thus, if the number of functions performed while a user is browsing a web page is greater than the number of the operations that the touch sensor can distinguish from one another, the communication apparatus is not allowed to accept instructions through intuitive operations.

More specifically, if a screen scroll function is assigned to an intuitive operation of tracing a web page in the horizontal direction, the screen scroll function cannot be assigned to a function for continuing or returning from the current web page. Thus, the communication apparatus needs to display a menu screen as necessary, and to accept a “continue” or “return” function from the menu through a touch operation. As a result, the number of user operations increases, and the user is prevented from smoothly browsing web pages.

It is conceivable that a user interface such as the control area of JP 2006-323793 is provided on a display area of the display at all times, and the continue/return function is performed by means of the above user interface A small-sized communication apparatus such as a mobile phone, however, has a display limited in size and its display area is limited. Thus, if a control area is provided, the display area assigned to a web page is reduced in size for that, resulting in that it becomes tough to browse the web page.

### SUMMARY OF THE INVENTION

Accordingly, an advantage of the present invention is that a communication apparatus having a touch sensor as an input device and being configured to allow intuitively operating a continue/return function provided in the web browser function with a small number of operations is provided.

To achieve the above advantage, one aspect of the present invention is to provide a communication apparatus having a touch screen, a memory and a controller, and configured to be used for visiting and browsing web pages. The touch screen is configured to display a visited web page, and to sense a first operation and a second operation performed on the touch screen. The first operation and the second operation are different from each other. The memory is configured to store history data of a plurality of visited web pages. The controller is configured to allow returning from a current web page to a preceding web page listed immediately before the current web page in the history data upon the touch screen sensing the first operation. The controller is configured to allow continuing from the current web page to a next web page listed immediately after the current web page in the history data upon the touch screen sensing the second operation.

The communication apparatus of the invention may have a display, an input device, a first controllers a memory and a second controller. The display is configured to provide a web page display area on which a web page is displayed. The input device has a touch sensor configured to sense a touch operation on the display so as to accept an input. The first controller is configured to change a layout of the web page in accordance with a width of the web page display area. The memory is configured to store data of the web page displayed on the web page display area. The second controller is configured to display a first web page displayed just before a second web page currently displayed on the basis of the data stored in the memory upon the touch sensor sensing a trace operation in almost a first horizontal direction after sensing a touch on the web page display area. The second controller is configured to display a third web page displayed just after the second web page currently displayed on the basis of the data stored in the memory upon the touch sensor sensing a trace operation in almost a second horizontal direction after sensing a touch on the web page display area.

The communication apparatus of the invention may have a display, an input device, a memory and a controller. The display is configured to provide a web page display area on which a web page is displayed and a data display area on which particular data is displayed outside the web page display area. The input device has a touch sensor configured to sense a touch operation on the display so as to accept an input. The memory is configured to store data of the web page displayed on the web page display area. The controller is configured to display a first web page displayed just before a second web page currently displayed on the basis of the data stored in the memory upon the touch sensor sensing a trace operation in almost a first horizontal direction after sensing a touch on the data display area. The controller is configured to display a third web page displayed just after the second web page currently displayed on the basis of the data stored in the memory upon the touch sensor sensing a trace operation in almost a second horizontal direction after sensing a touch on the data display area.

The communication apparatus of the invention may have a display, an input device, a first controller, a memory and a second controller. The display is configured to provide a web page display area on which a web page is displayed. The input device has a touch sensor configured to sense a touch operation on the display so as to accept an input. The first controller is configured to display a first image and a second image within the web page display area and at a first portion and a second portion, respectively. The memory is configured to store data of the web page displayed on the web page display area. The second controller is configured to display a first web page displayed just before a second web page currently displayed on the basis of the data stored in the memory upon the touch sensor sensing a flick operation after sensing a touch on the first image. The second controller is configured to display a third web page displayed just after the second web page currently displayed on the basis of the data stored in the memory upon the touch sensor sensing a flick operation after sensing a touch on the second image.

The communication apparatus of the invention may have a display, an input device, a first controller, a memory and a second controller. The display is configured to provide a web page display area on which a web page is displayed. The input device has a touch sensor configured to sense a touch operation on the display so as to accept an input. The first controller is configured to display a first image and a second image within the web page display area and at a first portion and a second portion, respectively. The memory is configured to store data of the web page displayed on the web page display area. The second controller is configured to display a first web page displayed just before a second web page currently displayed on the basis of the data stored in the memory upon the touch sensor sensing a trace operation after sensing a touch on the first image. The second controller is configured to display a third web page displayed just after the second web page currently displayed on the basis of the data stored in the memory upon the touch sensor sensing a trace operation after sensing a touch on the second image.

The communication apparatus of the invention can allow intuitively operating a continue/return function provided in the web browser function with a small number of operations even if having a touch sensor as an input device.

### BRIEF DESCRIPTION OF THE DRAWINGS

FIG. 1 is a perspective view showing a mobile phone, i.e., a communization device of an embodiment of the present invention.

FIG. 2 is a block diagram of the mobile phone of the embodiment.

FIG. 3 shows an example of a web page displayed on a touch screen of the mobile phone of the embodiment.

FIGS. 4A and 4B show an ordinary example of performing “return” and “continue” functions.

FIG. 5 shows a flowchart explaining a first web page browsing process performed by a main controller of the mobile phone of the embodiment.

FIG. 6 shows an example of a displayed web page in the first web page browsing process.

FIG. 7 shows a flowchart explaining a second web page browsing process performed by the main controller of the mobile phone of the embodiment.

FIG. 8 shows an example of a displayed web page in the second web page browsing process.

FIG. 9 shows another example of a displayed web page in the second web page browsing process.

FIG. 10 shows a flowchart explaining a third web page browsing process performed by the main controller of the mobile phone of the embodiment.

FIGS. 11A and 11B show an example of a displayed web page in the third web page browsing process.

### DETAILED DESCRIPTION OF THE INVENTION

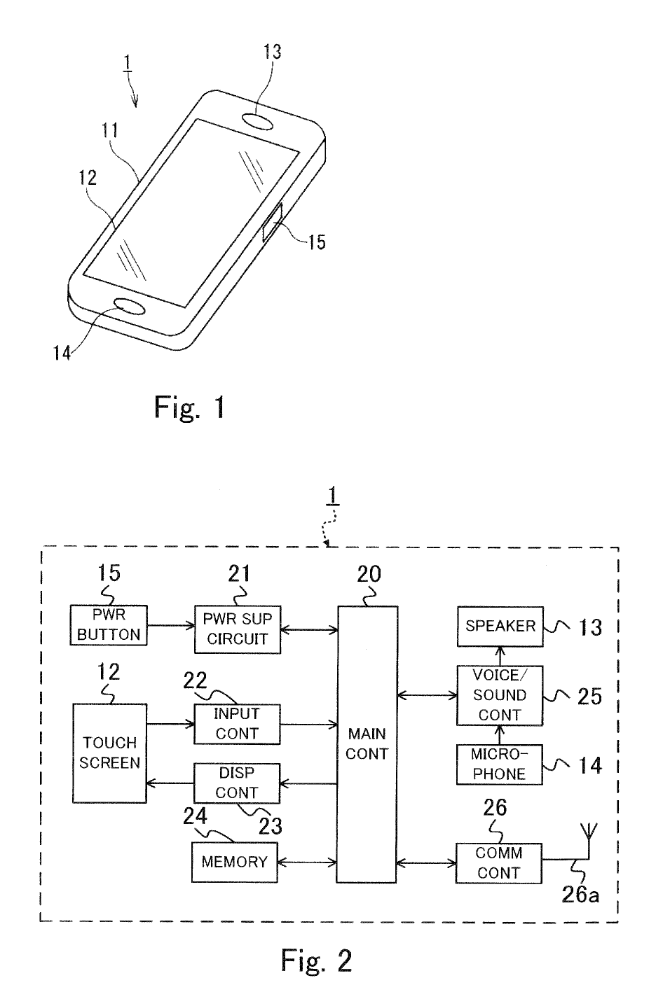

An embodiment of the present invention will be described with reference to FIGS. 1-11B. A card-shaped mobile phone 1 of the embodiment, which is so configured that a user can operate the mobile phone 1 by touching a display of the mobile phone 1 with his or her finger, will be described as an example of the invention FIG. 1 shows a perspective view of the mobile phone 1.

As shown in FIG. 1, the mobile phone 1 has a rectangular plate-like housing 11. The housing 11 is provided on one face with a touch screen 12, a speaker 13 and a microphone 14. The touch screen 12 occupies most of the face. The speaker 13 is arranged above the touch screen 12 in FIG. 1, and is configured to produce voice and sound. The microphone 14 is arranged below the touch screen 12, and can be used for entering voice and sound. The mobile phone 1 is provided with a power button 15 that can be pressed inwards so as to turn on and off power supply to the mobile phone 1.

The touch screen 12 has both a display function and an input function. For the display function, the touch screen 12 can be provided with a web page display area in which a screen such as a web page formed by text, an image and so on can be displayed For the input function, the touch screen 12 is provided with a touch sensor configured to detect a touch operation on the touch screen 12 so as to accept an input. The touch screen 12 is constituted by a display formed by, e.g., an LCD (liquid crystal display), a plurality of elements for detecting a touch on the surface of the display arranged on top of the display, and a transparent screen layered above the elements. Methods for detecting a touch on the touch screen 12 are a pressure sensing method for sensing a pressure change, an electrostatic method for sensing a signal caused by static electricity and so on.

The mobile phone 1 is configured to accept an input formed by a series of operations from the beginning of contact (called a touch) with the touch screen 12 to the end of the contact (called a release). The mobile phone 1 is configured to accept input operations such as a “touch operation”, a “trace operation” and a “flick operation”. For a “touch operation”, positions of the touch and the release on the touch screen 12 are almost the same. For a “trace operation”, the positions of the touch and the release are different and a certain distance apart from each other on a coordinate system. For a “flick operation”, the positions of the touch and the release are different and a certain distance apart from each other on the coordinate system and within a shorter period of time than that required for the “trace operation” (shorter than a given period of time). Although it is assumed with respect to the embodiment, hereafter, that the touch screen 12 is configured to accept a “touch operation”, a “trace operation” and a “flick operation”, the touch screen 12 may be configured to accept operations other than the above three kinds of operations.

FIG. 2 is a block diagram showing an internal configuration of the mobile phone 1 of the embodiment. The mobile phone 1 has a main controller 20, a power supply circuit 21, an input controller 22, a display controller 23, a memory 24, a voice/sound controller 25 and a communication controller 26 which are electrically connected to one another through a bus.

The main controller 20 has a CPU (central processing unit), and is configured to control the whole of the mobile phone 1. The main controller 20 is configured to perform a display control process, other various arithmetic and control processes and so on. The power supply circuit 21 is configured to turn on and off the power supply on the basis of a user input through the power button 15. If the power supply is turned on, the power supply circuit 21 supplies each of portions of the mobile phone 1 with power from a power source contained in the mobile phone 1 (a battery and so on) or a power source connected from the outside, so as to activate the mobile phone 1.

The input controller 22 has an input interface to the touch screen 12. The input controller 22 is configured, e.g., to sense pressure applied to the touch screen 12, to generate a signal indicating a position at which the pressure is applied, and to provide the main controller 20 with the signal. The display controller 23 has a display interface to the touch screen 12. The display controller 23 can be controlled by the main controller 20 so as to display a screen including text and an image on the touch screen 12.

The memory 24 is constituted by memory devices such as a ROM (read only memory), a hard disk, a non-volatile memory, a RAM (random access memory) and so on. The ROM is configured to store a program of a process to be performed by the main controller 20, data necessary for the process and so on. The RAM is configured to temporarily store data that the main controller 20 uses while performing the process. The memory 24 stores a program and data that the main controller 20 uses for a control process.

The voice/sound controller 25 can be controlled by the main controller 20 so as to produce an analog voice signal from a voice input coming through the microphone 14 and to transform the analog voice signal into a digital voice signal. Moreover, upon obtaining a digital voice signal, the voice/sound controller 25 can be controlled by the main controller 20 so as to transform the digital voice signal into an analog voice signal, and to produce voice from the speaker 13.

The communication controller 26 can be controlled by the main controller 20 so as to de-spread a spread-spectrum signal received from a base station through the antenna 26a so as to restore data carried by the received signal. The communication controller 26 can be directed by the main controller 20 to provide the data to the voice/sound controller 25 so that voice based on the data is produced through the speaker 13, to the display controller 23 so that the data is displayed on the touch screen 12, or to the memory 24 so that the data is stored in the memory 24.

Moreover, upon obtaining a voice signal entered through the microphone 14, data entered through the touch screen 12 or data stored in the memory 24, the communication controller 26 performs a spectrum spreading process on those data signals and sends them to the base station through the antenna 26a.

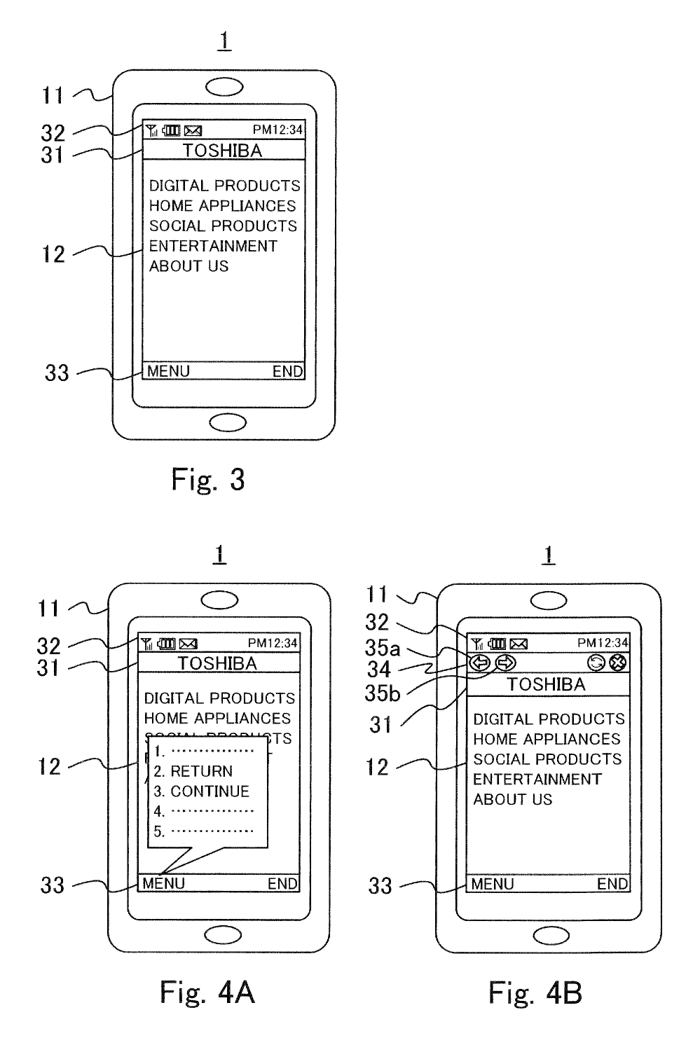

The mobile phone 1 of the embodiment has a web browser function for allowing a user of the mobile phone 1 to browse a web page obtained from a server that is not shown. FIG. 3 shows an example of a web page displayed on the touch screen 12 of the mobile phone 1 of the embodiment.

A display area on the touch screen 12 that works as a display while the web browser function of the mobile phone 1 is working is formed by a web page display area 31, a status indicator row 32 and a soft key label row 33. The touch sensor is provided on the display area for all the web page display area 31, the status indicator row 32 and the soft key label row 33.

The display controller 23 displays on the web page display area 31a screen of a web page that the main controller 20 directs the display controller 23 to display. The display controller 23 displays on the status indicator row 32 status indicators indicating the electromagnetic wave status, the remaining battery power and the presence of an unread email, and the current time. The display controller 23 displays on the soft key label row 33 functions which can be performed on the displayed web page, such as a “menu” function for activating a menu screen, an “end” function for ending the web browser function and so on. The status indicator row 32 and the soft key label row 33 are arranged above and below the web page display area 31, respectively, and are formed belt-like in the horizontal direction of the touch screen 12. The status indicator row 32 and the soft key label row 33 may be arranged above and below the web page display area 31, respectively, or both the status indicator row 32 and the soft key label row 33 may be arranged together above or below the web page display area 31.

The web browser function includes a function for sensing a touch operation on a hyperlink on a web page screen displayed on the web page display area 31 of the touch screen 12 so as to allow jumping to a linked page. The web browser function includes a function for sensing a trace operation in the horizontal and vertical directions on a web page screen so as to allow screen scrolling in the horizontal and vertical directions.

The memory 24 that works as a data storage device is configured to store history data of web pages displayed on the web page display area 31 (i.e., history of URLs (uniform resource locators) of the web pages). The memory 24 stores the history data of the web pages in order of browsing the web pages. The web browser function includes a “return” function for returning from a current page to a preceding page that is listed just before the current page in the above history data, and a “continue” function for continuing from the current page to a next page that is listed just after the current page in the above history data. In other words, the “continue” function can be used after the “return” function is used for coming back from the preceding page to the current page.

In order to perform the “return” function and the “continue” function through intuitive operations on the touch screen 12, it is conceivable, e.g., that right-to-left and left-to-right trace operations on the web page display area 31 are assigned to the “return” and “continue” functions, respectively. As described above, however, if the right-to-left and left-to-right trace operations on the web page display area 31 are assigned to the screen scroll function in the horizontal direction, the same trace operations cannot be assigned to the “return” function and the “continue” function.

FIGS. 4A and 4B show an ordinary example of performing the “return” and “continue” functions. As shown in FIG. 4A, first, if the “menu” key is touched on the soft label key indicator 33, the display controller 23 displays a menu screen 36. Then, on the displayed menu, the function of “2: RETURN” or “3: CONTINUE” can be touched and selected so that the corresponding function is performed. In comparison with an intuitive operation on the touch screen 12, however, the above example needs two stages of operations which are touching the key “menu” first and touching the key “2: RETURN” or “3: CONTlNUE” next, which can be bothering. Moreover, as being frequently used, the “return” and “continue” functions should be preferably performed through easier operations.

As shown in FIG. 4B, second, the display controller 23 can display a menu bar 34 related to the web browser function below the status indicator row 32 and between the status indicator row 32 and the web page display area 31. The display controller 23 displays on the menu bar 34 icons such as a return icon 35a that the “return” function is assigned to and a continue icon 35b that the “continue” function is assigned to. A user can touch the icon 35a or 35b so as to perform a “return” function or a “continue” function through one operation. As the menu bar 34 is provided, however, the web page display area 34 is reduced in size by the area of the menu bar 34.

Meanwhile, the mobile phone 1 of the embodiment can allow a user to perform a “return” or “continue” function through one intuitive operation. The mobile phone 1 of the embodiment can perform a plurality of (first to third) web page browsing processes which will be explained in detail hereafter. The main controller 20 can perform one of the first to third web page browsing processes which will be hereafter explained after the web browser function is activated upon a particular process being performed, e.g., activation of the web browser function directed through a user interface.

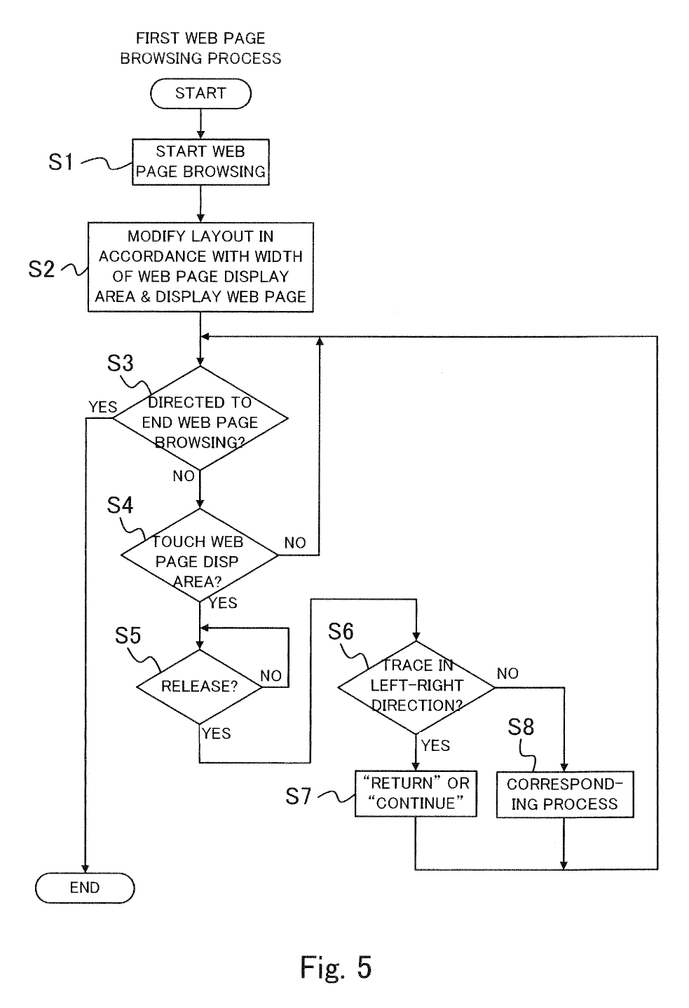

FIG. 5 shows a flowchart explaining the first web page browsing process performed by the main controller 20 of the mobile phone 1 of the embodiment. At a step S1, the main controller 20 starts the first web page browsing process. The main controller 20 obtains, from a server that is not shown, data of a web page of a preset URL or a web page of a URL entered as necessary.

At a step S2, the main controller 20 modifies a layout of the obtained web page in accordance with a horizontal width of the web page display area 31, and displays the web page on the web page display area 31 after modifying the layout. As the main controller 20 modifies the layout of the web page as described above, a user need not scroll the web page in the horizontal (left-right) direction for browsing the web page. The main controller 20 modifies the layout of the web page in such a way, e.g., as to convert HTML text that the mobile phone 1 has obtained into a layout configuration in accordance with the horizontal width of the web page display area 31.

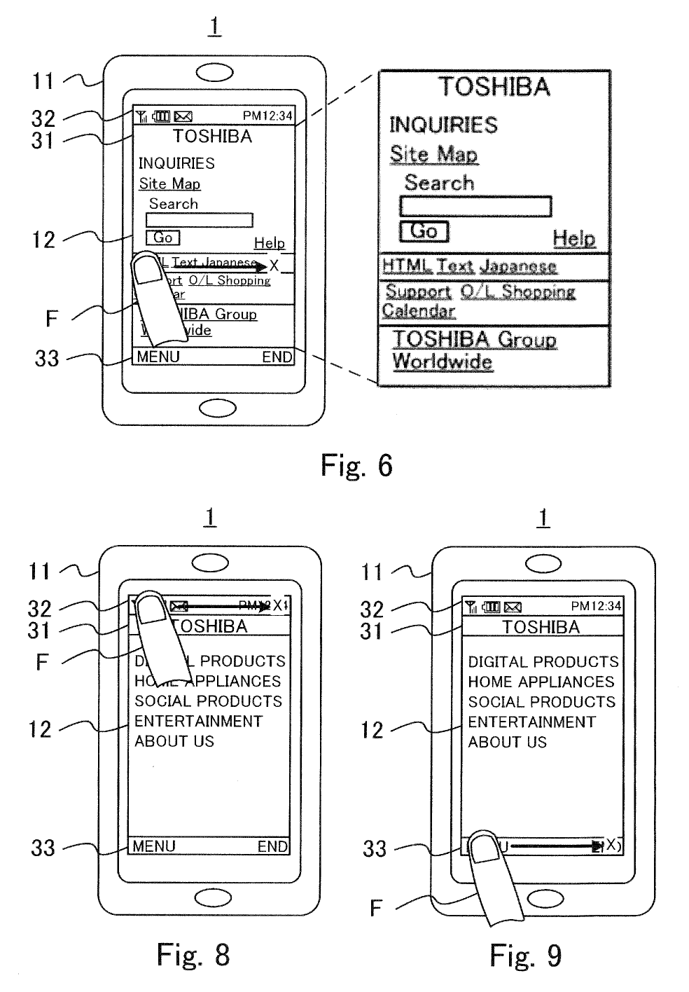

FIG. 6 shows an example of a displayed web page in the first web page browsing process. As shown in FIG. 6, the layout of the web page is modified and displayed in accordance with the horizontal width of the web page display area 31.

At a step S3, the main controller 20 judges whether the mobile phone 1 has been directed to end the web page browsing process by means of the web browser function. The mobile phone 1 is configured to be directed to end the web page browsing process, e.g., through a touch operation on an “end” key indicated on the soft key label row 33 of the touch screen 12. Upon judging that the mobile phone 1 has been directed to end the web browsing process, the main controller 20 ends the web browser function and the web browsing process.

Meanwhile, upon judging that the mobile phone 1 has not been directed to end the web browsing process, the main controller 20 judges at a step S4 whether a touch (beginning of contact) has been sensed on the web page display area 31. If the main controller 20 judges that no touch has been sensed on the web page display area 31, the process returns to the step S3, i.e., judging whether directed to end web browsing, and repeats the steps after S3. If a touch is sensed outside the web page display area 31, i.e., on the status indicator row 32 or on the soft key label row 33, the main controller 20 may either perform or omit the same process as in the case where the touch is sensed on the web page display area 31, which will not be explained as regards the embodiment though.

Meanwhile, upon judging that a touch has been sensed on the web page display area 31, the main controller 20 judges at a step S5 whether a release (end of contact), the opposite of the touch sensed at the step S4, has been sensed. Upon judging that no release has been sensed, the main controller 20 waits to sense a release.

Meanwhile, upon judging that a release has been sensed, the main controller 20 judges at a step S6 whether the operation done on the web page display area 31 was a trace operation in the left-right (horizontal) direction on the web page display area 31. More specifically, the main controller 20 judges whether the portion at which the touch was sensed on the touch screen 12 and the portion at which the release was sensed on the touch screen 12 are a certain distance apart from each other on the left-right coordinate. As shown in FIG. 6, e.g., the main controller 20 judges whether a move of a user's finger F was a left-to-right trace operation from somewhere on the web page display area 31 in a direction indicated by an arrow X. Otherwise, the main controller 20 judges whether the move of the user's finger F was a right-to-left trace operation from the end to the beginning of the arrow X in an opposite direction of the direction shown in FIG. 6. At this moment, it is preferable that the main controller 20 judge that the move of the finger F was a trace operation in the left-right direction not only in a case where the finger F moved on a straight line strictly left-to-right or right-to-left but also in a case where the finger F moved almost in the left-right direction (e.g., within ten percent of the height of the web page display area 31).

Upon judging that the operation on the web page display area 31 of the touch screen 12 was a left-right trace operation, the main controller 20 performs a “return” or “continue” operation at a step S7. Upon sensing a right-to-left trace operation in a first horizontal direction, the main controller 20 performs a “return” operation so as to return from the current web page to and display a preceding web page on the basis of the history data of the web pages stored in the memory 24. Meanwhile, upon sensing a left-to-right trace operation in a second horizontal direction, the main controller 20 performs a “continue” operation so as to continue from the current web page to and display a next web page on the basis of the history data of the web pages stored in the memory 24.

Meanwhile, upon judging that the operation on the web page display area 31 of the touch screen 12 was an operation except for a left-right trace operation, the main controller 20 performs at a step S8 a particular process corresponding to the above operation. If, e.g., a touch operation is performed on a hyperlink included in the web page, the main controller 20 performs an operation for jumping to and displaying a linked web page. If no particular process is assigned to the above operation, the main controller 20 does not react to the above operation. After the steps S7 and S8, the process returns to the step S3, i.e., judging whether directed to end web browsing, and repeats the steps after S3.

In the first web page browsing process, the mobile phone 1 displays a web page screen modified in such a way that the screen does not need scrolling in the left-right direction. Thus, trace operations on the web page screen in the left-to-right and right-to-left directions can be assigned to the “return” and “continue” functions, respectively.

The first and second horizontal directions are the right-to-left and left-to-right horizontal directions on the touch screen 12 as described above, respectively, and may be vice versa, as regards a following second web page browsing process as well. The explanation of the first web page browsing process ends here.

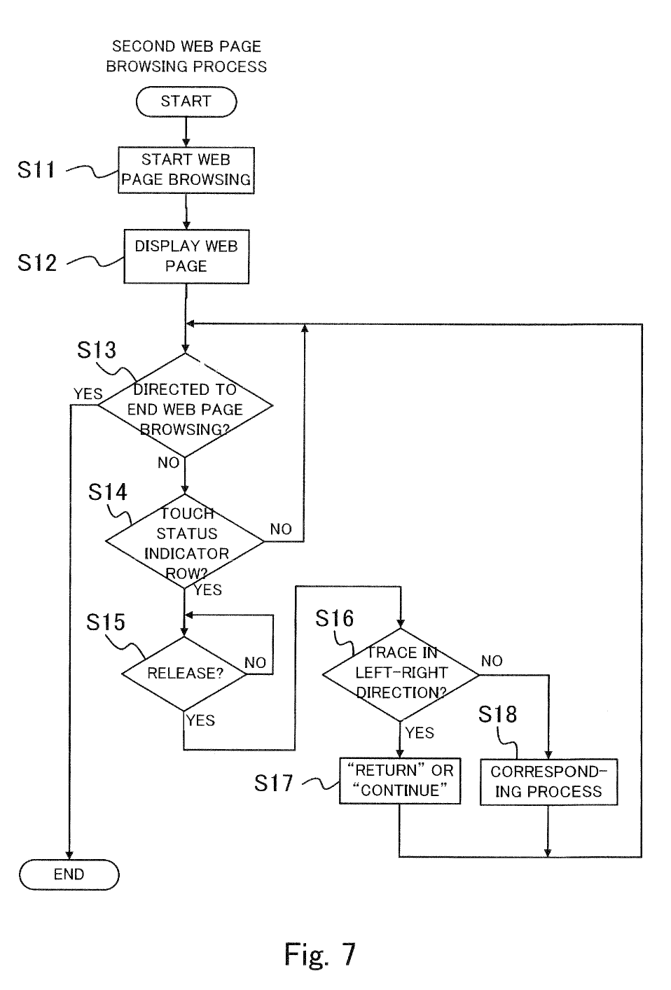

Then, the second web page browsing process will be explained. FIG. 7 shows a flowchart explaining the second web page browsing process performed by the main controller 20 of the mobile phone 1 of the embodiment. Content of the second web page browsing process that is common to the first web page browsing process will not be explained in detail. According to the second web page browsing process, the main controller 20 displays a web page screen on the web page display area 31 without modifying a layout of the web page, unlike the first web page browsing process.

At a step S11, the main controller 20 starts web page browsing. At a step S12, the main controller 20 displays the web page on the web page display area 31. Unlike the first web page browsing process, the main controller 20 displays a web page screen on the web page display area 31 without modifying a layout of the web page.

At a step S13, the main controller 20 judges whether the mobile phone 1 has been directed to end the web page browsing process by means of the web browser function. Upon judging that the mobile phone 1 has been directed to end the web browsing process, the main controller 20 ends the web browser function and the web browsing process.

Meanwhile, upon judging that the mobile phone 1 has not been directed to end the web browsing process, the main controller 20 judges at a step S14 whether a touch (beginning of contact) has been sensed on the status indicator row 32. If the main controller 20 judges that no touch has been sensed on the status indicator row 32, the process returns to the step S13, i.e., judging whether directed to end web browsing, and repeats the steps after S13. A process after a touch is sensed outside the status indicator row 32, i.e., on the web page display area 31 or on the soft key label row 33 will not be explained in detail as regards the embodiment (e.g., a URL access or a scroll process in vertical and horizontal directions is performed as usual).

Meanwhile, upon judging that a touch has been sensed on the status indicator row 32, the main controller 20 judges at a step S15 whether a release (end of contact), the opposite of the touch sensed at the step S14, has been sensed. Upon judging that no release has been sensed, the main controller 20 waits to sense a release.

Meanwhile, upon judging that a release has been sensed, the main controller 20 judges at a step S16 whether the operation done on the status indicator row 32 was a trace operation in the left-right (horizontal) direction on the status indicator row 32. FIG. 8 shows an example of a displayed web page in the second web page browsing process. As shown in FIG. 8, e.g., the main controller 20 judges whether a move of a user's finger F was a left-to-right trace operation from somewhere on the status indicator row 32 in a direction indicated by an arrow X. Otherwise, the main controller 20 judges whether the move of the user's finger F was a right-to-left trace operation from the end to the beginning of the arrow X in an opposite direction of the direction shown in FIG. 8.

Upon judging that the operation on the status indicator row 32 of the touch screen 12 was a left-right trace operation, the main controller 20 performs a “return” or “continue” operation at a step S17. Upon sensing a right-to-left trace operation in a first horizontal direction, the main controller 20 performs a “return” operation so as to return from the current web page to and display a preceding web page on the basis of the history data of the web pages stored in the memory 24. Meanwhile, upon sensing a left-to-right trace operation in a second horizontal direction, the main controller 20 performs a “continue” operation so as to continue from the current web page to and display a next web page on the basis of the history data of the web pages stored in the memory 24.

Meanwhile, upon judging that the operation on the status indicator row 32 of the touch screen 12 was an operation except for the left-right trace operation, the main controller 20 performs at a step S18 a particular process corresponding to the above operation. After the steps S17 and S18, the process returns to the step S13, i.e., judging whether directed to end web browsing, and repeats the steps after S13.

In the second web page browsing process, the mobile phone 1 is configured to assign the “return” and “continue” functions to the trace operations in the left-right directions, not on the web page display area 31 for displaying a web page screen but on the status indicator row 32. Thus, the scroll, “return” and “continue” functions of a web page screen can be assigned to the left-right trace operations on the web page area display 31 and on the status indicator row 32, respectively. Hence, the mobile phone 1 of the embodiment can be intuitively and easily directed to operate the “return” and “continue” functions as well as the scroll function of a web page screen.

In the second web browsing process, the “return” and “continue” functions on the web page screen are assigned to, although not limited to, trace operations on the status indicator row 32 in the left-right direction, and may be assigned to trace operations on the soft key label row 33. FIG. 9 shows another example of a displayed web page in the second web page browsing process. The “continue” and “return” functions are assigned to a left-to-right trace operation in that a user's finger F moves as indicated by an arrow X from somewhere on the soft key label row 33 as shown in FIG. 9, and to a right-to-left trace operation from the end to the beginning of the arrow X in an opposite direction of the direction shown in FIG. 9, respectively. According to the second web page browsing process, the “return” and “continue” functions on a web page screen can be assigned to left-right trace operations on the display areas, such as the status indicator row 32 and the soft key label row 33, for displaying particular data arranged outside the web page display area 31 for displaying a web page screen. The explanation of the second web page browsing process ends here.

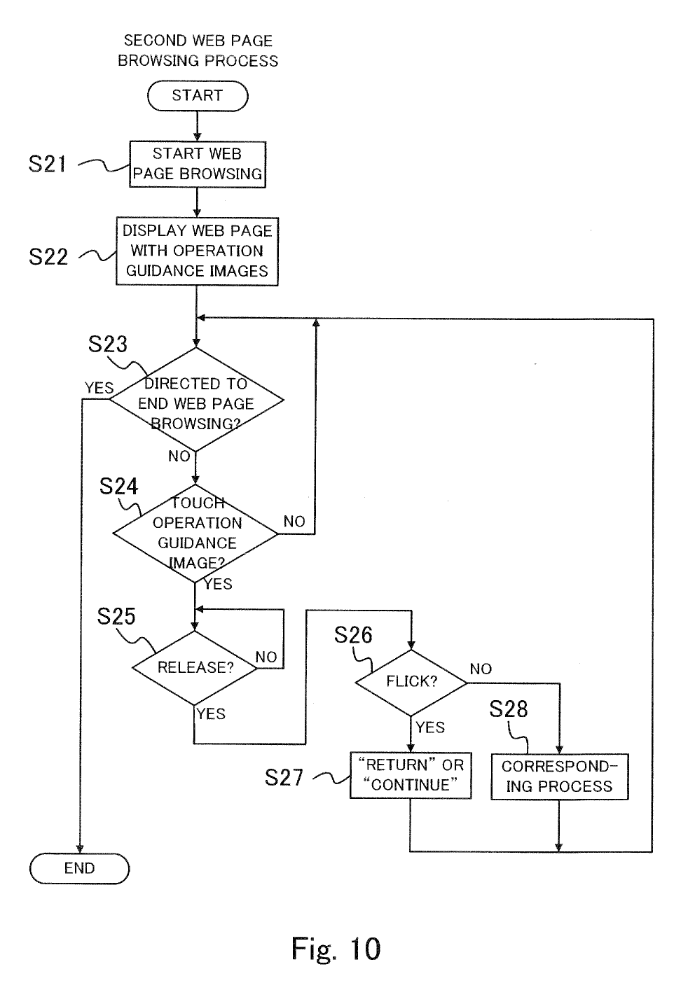

Then, a third web page browsing process will be explained. FIG. 10 shows a flowchart explaining the third web page browsing process performed by the main controller 20 of the mobile phone 1 of the embodiment. Content of the third web page browsing process that is common to the first web page browsing process will not be explained in detail.

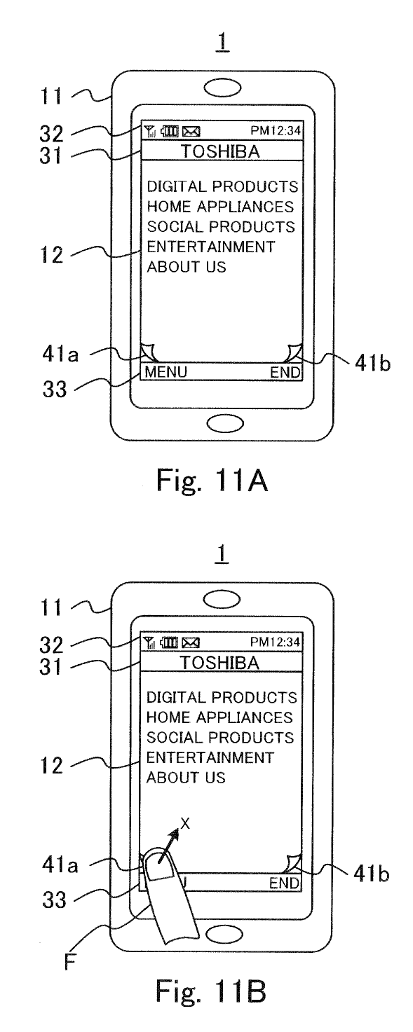

At a step S21, the main controller 20 starts web page browsing. At a step S22, the main controller 20 displays the web page on the web page display area 31. At this moment, the main controller 20 displays a first operation guidance image and a second operation guidance image at particular portions of the screen and within the web page display are 31. FIG. 11A shows an example of a displayed web page in the third web page browsing process. As shown in FIG. 11A, the main controller 20 displays operation guidance images 41a and 41b representing turned up corners of the page at lower left and lower right portions of the web page display area 31, respectively. The operation guidance image 41a displayed at the lower left of the screen implies returning from the current web page to a preceding web page listed just before the current web page in the history data stored in the memory 24. The operation guidance image 41b displayed at the lower right of the screen implies continuing from the current web page to a next web page listed just after the current web page in the history data stored in the memory 24.

At a step S23, the main controller 20 judges whether the mobile phone 1 has been directed to end the web page browsing process by means of the web browser function. Upon judging that the mobile phone 1 has been directed to end the web browsing process, the main controller 20 ends the web browser function and the web browsing process.

Meanwhile, upon judging that the mobile phone 1 has not been directed to end the web browsing process, the main controller 20 judges at a step S24 whether a touch (beginning of contact) has been sensed on the web page display area 31. If the main controller 20 judges that no touch has been sensed on the web page display area 31, the process returns to the step S23, i.e., judging whether directed to end web browsing, and repeats the steps after S23. A process after a touch is sensed on the web page display area 31 except for the operation guidance images 41a and 41b, on the status indicator row 32 or on the soft key label row 33 will not be explained in detail as regards the embodiment

Meanwhile, upon judging that a touch has been sensed on the operation guidance image 41a or 41b, the main controller 20 judges at a step S25 whether a release (end of contact), the opposite of the touch sensed at the step S24, has been sensed. Upon judging that no release has been sensed, the main controller 20 waits to sense a release.

Meanwhile, upon judging that a release has been sensed, the main controller 20 judges at a step S26 whether the operation done on the operation guidance image 41a or 41b was to flick the operation guidance image 41a or 41b. As shown in FIG. 11B, e.g., the main controller 20 judges whether a move of a user's finger F was a flick operation from the position of the operation guidance image in a direction indicated by an arrow X. The direction in which the user's finger F flicks the operation guidance image 41a or 41b is not limited to the direction of the arrow X, and may be vertical, horizontal or right- or left-upwards.

Upon judging that the operation on the operation guidance image 41a or 41b was a flick operation, the main controller 20 performs a “return” or “continue” operation at a step S27. Upon sensing a flick operation on the operation guidance image 41a, the main controller 20 performs a “return” operation so as to return from the current web page to and display a preceding web page on the basis of the history data of the web pages stored in the memory 24. Meanwhile, upon sensing a flick operation on the operation guidance image 41b, the main controller 20 performs a “continue” operation so as to continue from the current web page to and display a next web page on the basis of the history data of the web pages stored in the memory 24.

Meanwhile, upon judging that the operation on the operation guidance image 41a or 41b of the touch screen 12 was an operation except for a flick operation, the main controller 20 performs at a step S28 a particular process corresponding to the above operation. If no particular process is assigned to the above operation, the main controller 20 does not react to the above operation. After the steps S27 and S28, the process returns to the step S23, i.e., judging whether directed to end web browsing, and repeats the steps after S23.

In the third web page browsing process, the mobile phone 1 is configured to display the operation guidance images 41a and 41b representing turned up corners of the page at the lower left and lower right portions where a web page screen can be less probably prevented from being viewed. Moreover, the flick operations on the operation guidance images 41a and 41b are assigned to performing the “return” and “continue” functions, respectively. Thus, the “return” and “continue” functions can be intuitively performed.

The mobile phone 1 is configured to assign the flick operations on the operation guidance images 41a and 41b to the “return” and “continue” functions, respectively. The mobile phone 1 is configured to assign trace operations which start from the operation guidance images 41a and 41b to the “return” and “continue” functions, respectively. In such a case, the mobile phone 1 may be so configured that the direction of the trace operation is not specified, as long as the trace operation starts from the operation guidance image 41a or 41b.

The operation guidance images 41a and 41b are not limited to the ones representing turned up corners of the page, and may be other images. The positions of the operation guidance images 41a and 41b are not limited to the lower left and lower right portions of the screen, and may be other portions of the screen. The operation guidance images 41a and 41b should be preferably located on the web page screen in such a way that the return to the preceding page and the continuation to the next page can be intuitively recognized.

Although having a touch sensor as an input device, the mobile phone 1 is so configured that the “return” and “continue” functions of the web browser function can be intuitively operated with a small number of operations.

The mobile phone 1 can implement each of the first to third web page browsing processes independently. The mobile phone 1 can be set in a plurality of modes corresponding to the first to third web page browsing processes each, so that a user can select one of the modes at will and intuitively operate the mobile phone 1 in accordance with his or her preference.

The embodiment described above includes an example of a web browser function that the present invention is applied to. The present invention can be applied to another browser function of text or images that can use “return” and “continue” functions.

The communication apparatus of the present invention is not limited to one having only a touch sensor as an input device, and may be applied to one having an operation key in addition to a touch panel.

The mobile phone 1 has been explained as a mobile communication apparatus of the present invention, which is not limited to the mobile phone 1 though, and can be any kind of communication device having a touch screen such as a PHS (personal handy phone system) device, a PDA (personal digital assistant), a portable music player, a portable game machine and so on.

What is claimed is:

1. A communication apparatus configured to be used for visiting and browsing web pages, comprising:
a touch screen configured to display a visited web page, the touch screen being configured to sense a first operation and a second operation performed on the touch screen, the first operation and the second operation being different from each other;
a memory configured to store history data of a plurality of visited web pages; and
a controller configured to allow returning from a current web page to a preceding web page listed immediately before the current web page in the history data upon the touch screen sensing the first operation, the controller being configured to allow continuing from the current web page to a next web page listed immediately after the current web page in the history data upon the touch screen sensing the second operation.

2. The communication apparatus of claim 1, wherein
the touch screen is further configured to display the visited web page in accordance with a width of the touch screen without a need of scrolling in a first direction of the width, and
the first operation is a trace operation in the first direction of the width on the touch screen.

3. The communication apparatus of claim 1, wherein
the touch screen is further configured to display the visited web page in accordance with a width of the touch screen without a need of scrolling in a first direction of the width,
the first operation is a trace operation in the first direction of the width on the touch screen, and
the second operation is a trace operation in an opposite direction of the first direction on the touch screen.

4. The communication apparatus of claim 1, wherein
the touch screen is further configured to be divided into a first area and a second area, the touch screen being configured to display the visited web page in the first area, and
the first operation is a trace operation on the second area of the touch screen in a first direction of a width of the touch screen.

5. The communication apparatus of claim 1, wherein
the touch screen is further configured to be divided into a first area and a second area, the touch screen being configured to display the visited web page in the first area,
the first operation is a trace operation on the second area of the touch screen in a first direction of a width of the touch screen, and
the second operation is a trace operation on the second area of the touch screen in an opposite direction of the first direction.

6. The communication apparatus of claim 4, wherein the second area is one of a status indicator row and a soft key label row.

7. The communication apparatus of claim 4, wherein
the touch screen is further configured to scroll the visited web page in the first direction upon sensing a trace operation in the first direction on the first area of the touch screen.

8. The communication apparatus of claim 4, wherein
the touch screen is further configured to scroll the visited web page in the first direction upon sensing a trace operation in the first direction on the first area of the touch screen, and
the touch screen is still further configured to scroll the visited web page in an opposite direction of the first direction upon sensing a trace operation in the opposite direction of the first direction on the first area of the touch screen.

9. The communication apparatus of claim 1, wherein
the touch screen is further configured to display a first operation guidance image and a second operation guidance image at a first portion and a second portion of the touch screen, respectively,
the first operation is a flick operation on the first portion of the touch screen, and
the second operation is a flick operation on the second portion of the touch screen.

10. The communication apparatus of claim 1, wherein
the touch screen is further configured to display a first operation guidance image and a second operation guidance image at a first portion and a second portion of the touch screen, respectively,
the first operation is a trace operation on the touch screen starting from the first portion, and
the second operation is a trace operation on the touch screen starting from the second portion.

11. A method for visiting and browsing web pages by means of a communication apparatus having a memory and a touch screen, comprising:
displaying a visited web page on the touch screen;
storing history data of a plurality of visited web pages;
returning from a current web page to a preceding web page listed immediately before the current web page in the history data upon sensing a first operation on the touch screen, and
continuing from a current web page to a next web page listed immediately after the current web page in the history data upon sensing a second operation on the touch screen, the second operation being different from the first operation.

12. The method for visiting and browsing web pages of claim 11, wherein
the visited web page is displayed on the touch screen in accordance with a width of the touch screen without a need of scrolling in a first direction of the width, and
the first operation is a trace operation in the first direction of the width on the touch screen.

13. The method for visiting and browsing web pages of claim 11, wherein
the visited web page is displayed on the touch screen in accordance with a width of the touch screen without a need of scrolling in a first direction of the width,
the first operation is a trace operation in the first direction of the width on the touch screen, and
the second operation is a trace operation in an opposite direction of the first direction on the touch screen.

14. The method for visiting and browsing web pages of claim 11, further comprising dividing the touch screen into a first area and a second area, wherein
the visited web page is displayed in the first area, and
the first operation is a trace operation in a first direction on the second area of the touch screen of a width of the touch screen.

15. The method for visiting and browsing web pages of claim 11, further comprising dividing the touch screen into a first area and a second area, wherein
the visited web page is displayed in the first area,
the first operation is a trace operation in a first direction of a width of the touch screen on the second area of the touch screen, and
the second operation is a trace operation in an opposite direction of the first direction on the second area of the touch screen.

16. The method for visiting and browsing web pages of claim 14, wherein the second area is one of a status indicator row and a soft key label row.

17. The method for visiting and browsing web pages of claim 14, further comprising
scrolling the visited web page in the first direction upon sensing a trace operation in the first direction on the first area of the touch screen.

18. The method for visiting and browsing web pages of claim 14, further comprising
scrolling the visited web page in the first direction upon sensing a trace operation in the first direction on the first area of the touch screen, and
scrolling the visited web page in an opposite direction of the first direction upon sensing a trace operation in the opposite direction of the first direction on the first area of the touch screen.

19. The method for visiting and browsing web pages of claim 14, further comprising displaying a first operation guidance image and a second operation guidance image at a first portion and a second portion of the touch screen, respectively, wherein
the first operation is a flick operation on the first portion of the touch screen, and
the second operation is a flick operation on the second portion of the touch screen.

20. The method for visiting and browsing web pages of claim 14, further comprising displaying a first operation guidance image and a second operation guidance image at a first portion and a second portion of the touch screen, respectively, wherein
the first operation is a trace operation on the touch screen starting from the first portion, and
the second operation is a trace operation on the touch screen starting from the second portion.
